(19) United States
(12) Patent Application Publication
(10) Pub. No.: US 2009/0152089 A1
(43) Pub. Date: Jun. 18, 2009

(54) APPLIANCE BUTTON

(75) Inventor: Adam Hanes, Glen Allen, VA (US)

Correspondence Address: PANITCH SCHWARZE BELISARIO & NADEL LLP, ONE COMMERCE SQUARE, 2005 MARKET STREET, SUITE 2200, PHILADELPHIA, PA, 19103, US

(73) Assignee: HAMILTON BEACH BRANDS, INC., Glen Allen, VA (US)

(21) Appl. No.: 11/958,473

(22) Filed: Dec. 18, 2007

(51) Int. Cl. H01H 13/02

(52) U.S. Cl. 200/345

(57) ABSTRACT

An appliance button for use in an appliance that has a housing, a button opening in the housing and a control structure within the housing. The appliance button includes a push button with a distal end of the push button that extends outwardly through the button opening in the housing. A button stem is located within the housing and is aligned with the push button. A proximal end of the button stem is operably connected to the control structure. A deflector is located within the housing and positioned between the button stem and the push button.

### BACKGROUND OF THE INVENTION

This invention generally relates to an appliance button and, more particularly, to an appliance button having a deflector for preventing liquid from contacting the internal electrical components of the appliance.

Small kitchen appliances such as mixers, blenders and food processors contain electrical components. Because small appliances are often exposed to liquid through overfills, spills and attempts to clean the exterior, it is desirable to provide an outer housing that safely shields the electrical components from such liquid to prevent shortages, corrosion and electric shock. However, appliances with push buttons often have a plurality of button openings in the housing. The button openings prevent the housing from having a water-tight seal and allow liquid that is running down the exterior of the housing to enter the interior of the housing.

In order to prevent liquid from reaching the electrical components, a thin protective cover is often used to cover the electrical components within the housing. The cover typically blocks a high enough percentage of liquid to allow the appliance to pass the safety requirements set forth by the Underwriters Laboratory (UL). However, due to surface tension and other factors liquid may still run down the button stem and, between the button stem and the cover to contact the electrical components. The liquid slips past the cover especially in heavy liquid flow scenarios, not tested by the UL standards.

What is therefore desirable, but not provided in the prior art, is an appliance button that reduces the likelihood that liquid entering the housing through the button openings will contact the electrical components of the appliance.

### BRIEF SUMMARY OF THE INVENTION

Briefly stated, the present invention is directed to an appliance button for use in an appliance that has a housing, a button opening in the housing and a control structure within the housing. The appliance button includes a push button with a distal end of the push button that extends outwardly through the button opening in the housing. A button stem is located within the housing and is aligned with the push button. A proximal end of the button stem is operably connected to the control structure. A deflector is located within the housing and positioned between the button stem and the push button.

In another aspect, the invention is directed to an appliance button for use in an appliance having a housing, a button opening in the housing and a control structure within the housing. The appliance button includes a push button with a distal end of the push button that extends outwardly through the button opening in the housing. A button stem is located within the housing and is aligned with the push button. A proximal end of the button stem is operably connected to the control structure. A deflector extends from push button and is positioned between the button opening and the control structure.

### BRIEF DESCRIPTION OF THE SEVERAL VIEWS OF THE DRAWINGS

The foregoing summary, as well as the following detailed description of a preferred embodiment of the invention, will be better understood when read in conjunction with the appended drawings. For the purpose of illustrating the invention, there is shown in the drawings an embodiment which is presently preferred. It should be understood, however, that the invention is not limited to the precise arrangements and instrumentalities shown.

In the drawings:

FIG. 1 is a perspective view of a plurality of appliance buttons within an appliance housing in accordance with a preferred embodiment of the present invention;

FIG. 2 is an enlarged perspective view of the plurality of appliance buttons shown in FIG. 1 attached to a control structure; and

FIG. 3 is a cross sectional side elevational view of one of the plurality of appliance buttons attached to the control structure shown in FIG. 2 taken along lines 3-3 of FIG. 2.

### DETAILED DESCRIPTION OF THE INVENTION

Certain terminology is used in the following description for convenience only and is not limiting. The words “right,” “left,” “lower” and “upper” designate directions in the drawings to which reference is made. The words “inwardly” and “outwardly” refer to directions toward and away from, respectively, the geometric center of an appliance button in accordance with the present invention, and designated parts thereof. Unless specifically set forth herein, the terms “a”, “an” and “the” are not limited to one element but instead should be read as meaning “at least one”. The terminology includes the words noted above, derivatives thereof and words of similar import.

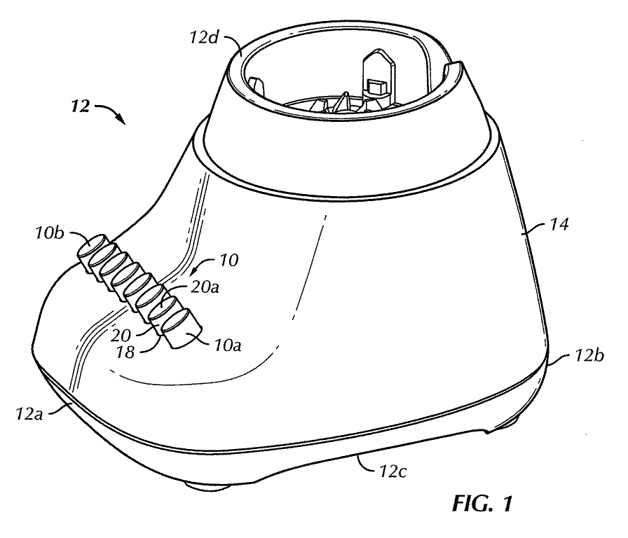

Referring to the drawings in detail, where like numerals indicate like elements throughout, there is shown in FIGS. 1-3 a preferred embodiment of an appliance button, generally designated 10, for use in an appliance, generally designated 12. The appliance 12 is preferably a blender for blending and mixing foodstuff (not shown). However, it is within the spirit and scope of the present invention that the appliance 12 be any electrical device having push buttons that are subjected to liquid exposure such as but not limited to food processors and stereos.

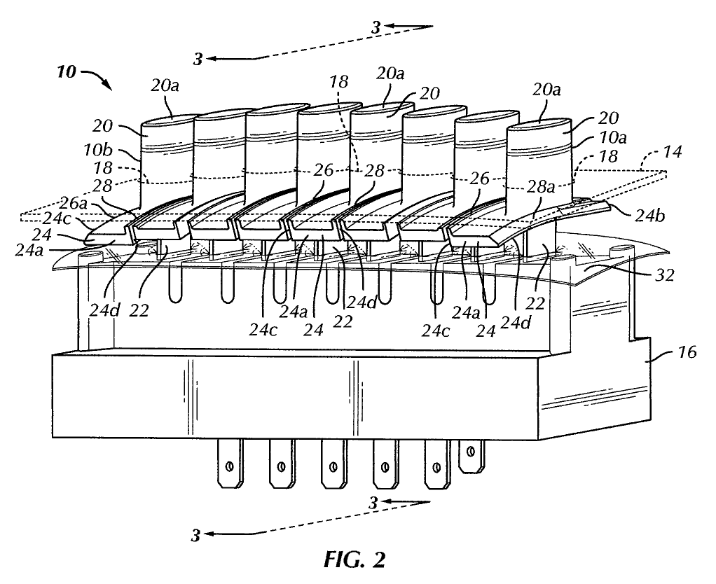

Referring to FIG. 1, the appliance 12 includes a housing 14. The housing 14 serves as a decorative body as well as a protective outer shell to protect a control box or structure 16 (FIG. 2) containing the electrical components within the housing 14. The details of the control structure 16 and the electrical components within is omitted for convenience only, as such detail is well known in the art, and omission of such detail is not limiting. The appliance 12 has a front end 12a a rear end 12b a bottom 12c for resting on a planer support surface (not shown) and a top 12d. The appliance 12 and the housing 14 may have any shape and configuration. The housing 14 includes a plurality of generally oval shaped button openings 18 for receiving a plurality of corresponding appliance activating or control buttons 10. The plurality of appliance buttons 10 are preferably similar with the exception of the outermost appliance buttons 10a, 10b described further below.

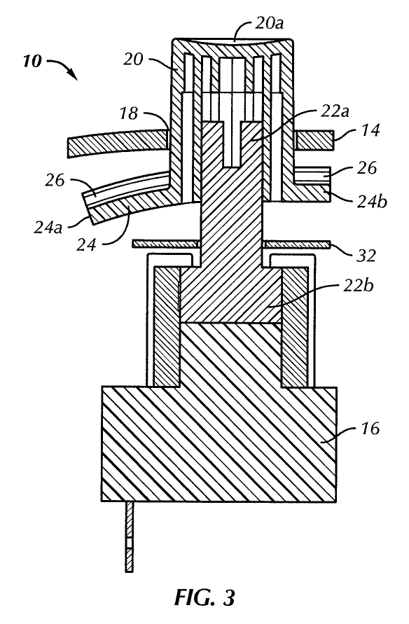

Referring to FIGS. 2-3, the appliance buttons 10 are each comprised of a push button 20. A distal end 20a of each push button 20 extends outward/upwardly through the corresponding button opening 18 in the housing 14. The push buttons 20 are preferably at least slightly smaller than the size of the button openings 18 such that the push buttons 20 can slide in and out of the housing 14. The push buttons 20 preferably have a generally oval cylindrical shape and are preferably molded from a polymeric material. However, it is within spirit and scope of the present invention that the push buttons 20 be comprised of any shape such as rectangular and be comprised of any suitable material.

Each appliance button 10 includes a button stem 22. The button stem 22 is substantially positioned within the housing 14 and is inline with the corresponding push button 20. Each push button 20 is mounted over a distal end 22a of the corresponding button stem 22. The push button 22 is preferably slidingly attached to the button stem 22. However, it is within the spirit and scope of the present invention that the push button 20 be secured to the button stem 22 in any manner such as a snap fit, use of adhesive or that the push button 20 and the button stem 22 be integrally formed. A proximal end 22b of the button stem 22 is operably connected to a device such as a switch within the control structure 16. As the button stem 22 is urged vertically downwardly into the control structure 16 the button stem 22 activates the electrical switch (not shown) to operate one or more predetermined functions of the appliance 12. The button stem 22 is preferably rectangularly shaped and thin having smaller horizontal dimensions than the push button 20. However, it is within the spirit and scope of the present invention that the button stem 22 have any shape and be sized equal to or larger than the push button 20.

The appliance button 10 further includes a deflector 24. The deflector 24 is located within the housing 14 and is positioned between the button stem 22 and the push button 20. The push button 20 and the deflector 24 are preferably co-molded such the push button 20 and the deflector 24 are integrally formed. However, it is within the spirit and scope of the present invention that the push button 20 and deflector 24 be comprised of separate components that are assembled together after being manufactured.

The deflector 24 preferably extends laterally further than the push button 20 and the button stem 22 such that looking downwardly on the appliance button 10 from the top of the appliance 12 with the housing 14 removed, the button stem 22 would not be visible. The deflector 24 is also preferably larger than the button opening 18.

The deflector 24 extends at least partially toward the front and bottom ends 12a, 12c of the appliance 12 such that a front section 24a of the deflector 24 is at least partially convex to fit the shape of the housing 14 and to direct liquid as described in further detail below. A rear portion 24b of the deflector 24 preferably extends toward the rear 12b of the appliance 12 and is generally planer and tilted slightly toward the top of the appliance 12 due to the forward slant of the appliance buttons 10. The deflector 24 preferably includes a first side guide rail 26 proximate a first lateral side 24b of the deflector 24. The first side guide rail 26 extends upwardly toward the button opening 18. The deflector 24 also preferably includes a second side guide rail 28 proximate a second lateral side 24c of the deflector 24. The second side guide rail 28 extends upwardly toward the button opening 18. The first and second guide rails 26, 28 form a trough 30 therebetween for directing liquid (not shown) that enters the housing 14 through the button openings 18 toward the front end 12a of the appliance 12 away from the button stem 22. The first and last appliance buttons 10a, 10b within a row of a plurality of appliance buttons 10 preferably do not include an outer guide rail 26, 28. Instead, appliance buttons 10a, 10b preferably have an outer downward slant 26a, 28a. Though it is preferred that the deflector 24 have a convexly shaped front portion 24a and planer rear portion 24b and first and second guide rails 26, 28, it is within the spirit and scope of the present invention that the deflector 24 be any shape capable of deflecting liquid that enters the housing 14 through the button openings 18 away from the button stem 22.

The appliance 12 preferably includes a thin protective water resistant cover 32 such as Mylar to surround at least the upper portion of the control structure 16. The cover 32 helps to protect the control structure 16 from liquid entering the control structure 16 and damaging the electrical components. However, because the button stems 22 must be slidingly disposed through the cover 32, there is potential that liquid will enter the control structure 16 between the cover 32 and the button stems 22. The deflectors 24 helps to deflect or direct the liquid entering through the housing 14 away from the button stems 22 such that liquid is prevented from entering the control structure 16 that would otherwise run down the button stems 22 past the cover 32.

It will be appreciated by those skilled in the art that changes could be made to the embodiment described above without departing from the broad inventive concept thereof. It is understood, therefore, that this invention is not limited to the particular embodiment disclosed, but it is intended to cover modifications within the spirit and scope of the present invention as defined by the appended claims.

I claim:

1. An appliance button for use in an appliance having a housing, a button opening in the housing and a control structure within the housing, the appliance button comprising:
a push button, a distal end of the push button extending outwardly through the button opening in the housing;
a button stem located within the housing and aligned with the push button, a proximal end of the button stem operably connected to the control structure; and
a deflector located within the housing and positioned between the button stem and the push button.

2. The appliance button of claim 1, wherein the deflector extends laterally further than the push button and the button stem.

3. The appliance button of claim 1, wherein the deflector is larger than the button opening.

4. The appliance button of claim 1, wherein the deflector is at least partially convex.

5. The appliance button of claim 1, wherein the deflector extends at least partially toward the bottom front of the appliance.

6. The appliance button of claim 5, wherein a portion of the deflector extends toward the rear of the appliance and is generally planar.

7. The appliance button of claim 1, wherein the deflector includes a first side guide rail proximate a first lateral side of the deflector which extends upwardly toward the button opening.

8. The appliance button of claim 7, wherein the deflector includes a second side guide rail proximate a second lateral side of the deflector which extends upwardly toward the button opening.

9. The appliance button of claim 8, wherein the first and second side guide rails form a trough therebetween for directing liquid away from the button stem.

10. The appliance button of claim 9, wherein the trough directs liquid toward the front of the appliance

11. The appliance button of claim 1 further comprising a water resistant film between the control structure and the deflector.

12. The appliance button of claim 1, wherein the push button and the deflector are integrally formed.

13. The appliance button of claim 12, wherein the push button is mounted over the distal end of the button stem.

14. The appliance button of claim 1, wherein the appliance is a blender.

15. An appliance button for use in an appliance having a housing, a button opening in the housing and a control structure within the housing, the appliance button comprising:
a push button, a distal end of the push button extending outwardly through the button opening in the housing;
a button stem located within the housing and aligned with the push button, a proximal end of the button stem operably connected to the control structure; and
a deflector extending from push button and positioned between the button opening and the control structure.
